(19) United States
(12) Patent Application Publication
(10) Pub. No.: US 2014/0259171 A1
(43) Pub. Date: Sep. 11, 2014

(54) TUNABLE INTRUSION PREVENTION WITH FORENSIC ANALYSIS

(71) Applicant: Spikes, Inc., Campbell, CA (US)

(72) Inventors: Branden L. Spikes, Saratoga, CA (US); Walter Sims, Saratoga, CA (US)

(73) Assignee: Spikes, Inc., Campbell, CA (US)

(21) Appl. No.: 14/205,085

(22) Filed: Mar. 11, 2014

Related U.S. Application Data
(60) Provisional application No. 61/775,861, filed on Mar. 11, 2013.

(51) Int. Cl. H04L 29/06

(52) U.S. Cl. CPC H04L 63/1441
USPC 726/23

(57) ABSTRACT

An intrusion prevention system for use in a networked server-client system includes a server interactively connected with a client over a network, the server including: a user device activity sensor configured to detect one or more of activity and inactivity; an intrusion alarm prompter configured to prompt an alarm under predetermined conditions; and intrusion event correlation software operably connected with the user device activity sensor, wherein the intrusion event correlation software is operably connected with the intrusion alarm prompter, so as to prevent intrusions into the server-client system.

### PRIORITY CLAIM

The present application claims the priority benefit of U.S. provisional patent application No. 61/775,861 filed Mar. 11, 2013 and entitled “Intrusion Prevention,” the disclosure of which is incorporated herein by reference.

### CROSS-REFERENCE TO RELATED APPLICATIONS

This application contains subject matter that is related to the subject matter of the following applications, which are assigned to the same assignee as this application. The below-listed U.S. patent applications are hereby incorporated herein by reference in their entirety:
“DYNAMIC CLIP ANALYSIS,” by Spikes and Sims, co-filed herewith.
“APPLICATION MALWARE ISOLATION VIA HARDWARE SEPARATION,” by Spikes, to be filed on Mar. 12, 2014, to claim the priority benefit of U.S. provisional patent application No. 61/777,545 filed Mar. 12, 2013 and entitled “Application Malware Isolation Via Hardware Separation.”

### SUMMARY

An intrusion detection system (IDS) is a device or software application that monitors one or more of network activities and system activities for one or more of malicious activities and policy violations. The IDS then generates reports on the results of its monitoring, which it may transmit to a management station. Traditional intrusion detection occurs by applying detection mechanisms to a general purpose system, which may result in a high degree of false positives and which may require meticulous training of the policy so that it is sophisticated enough not to be triggered by expected behaviors.

According to embodiments of the invention, an IDS may be further configured to prevent intrusions. Such systems may be called Intrusion Detector & Preventer (IDP) systems.

According to embodiments of the invention, intrusion prevention techniques can be tuned to the requirements of a particular application. Gain far better accuracy. According to embodiments of the invention, control is obtained over both ends of client-server communication so that the intrusion prevention parameters can be tuned to expected events.

According to other embodiments of the invention, the system is able to determine whether one or more of system activity and system inactivity is expected or suspicious. According to still other embodiments of the invention, the system can ignore one or more of expected system activity and expected system inactivity. According to yet other embodiments of the invention, upon discovering one or more of unexpected activity and unexpected inactivity, the system undertakes forensic activities.

Embodiments of the invention may be applied to any single purpose client-server application. Embodiments of the invention may be applied to the U.S. patent application entitled, “APPLICATION MALWARE ISOLATION VIA HARDWARE SEPARATION,” by Spikes, filed on Mar. 12, 2014, to be filed on Mar. 12, 2014, to claim the priority benefit of U.S. provisional patent application No. 61/777,545 filed Mar. 12, 2013 and entitled “Application Malware Isolation Via Hardware Separation.”

According to embodiments of the invention, IDP software may detect malware before it transmits information and before it can be controlled by a hacker.

According to embodiments of the invention, a hypervisor alerting engine may issue an alarm whenever an atypical event occurs in an application that may indicate the presence of malware. The hypervisor alerting engine may be specialized to the application. For example, according to embodiments of the invention, malware may be identified if a file system is accessed by non-application processes. As one more specific example, according to embodiments of the invention, in an environment specialized for Internet browsing, malware may be identified if the file system is accessed by non-browser processes.

For example, according to embodiments of the invention, malware is identified if abnormal areas of the file system are accessed by the application. For example, according to embodiments of the invention, malware is identified if network connections are made on ports other than ports 80 and 443. For example, according to embodiments of the invention, malware is identified if areas of memory are read outside of the normal application memory areas.

Embodiments of the invention may be applied to elements of the operating environment other than the application. Embodiments of the invention may dramatically improve on the accuracy currently attainable by the existing IDS art.

According to other embodiments of the invention, background noise may be lowered so that false positives may be reduced. According to yet other embodiments of the invention, one or more of the client, the server, and communications between the client and the server are controlled so as to minimize background noise. By contrast with embodiments of the invention, conventional IDSs run on multi-purpose operating environments and use one or more of heuristics and policies to identify malware.

According to embodiments of the invention, the IDP system collaborates with the client agent to optimize the process of identifying malware. For example, according to embodiments of the invention, if activity occurs with one or more of a clipboard, downloads, and printing, at a time when the client is idle or the desktop is on screen saver or the desktop is locked, active malware may be diagnosed. For example, according to embodiments of the invention, if inactivity occurs with one or more of a clipboard, downloads, and printing, at a time when the client is active, active malware may be diagnosed.

According to embodiments of the invention, an intrusion event triggers a sequence of one or more prescribed actions. According to other embodiments of the invention, the prescribed actions may comprise one or more of mitigating content loss, capturing forensic data, logging forensic data, modeling behaviors, matching behaviors, halting one or more networks, halting one or more content write operations, halting one or more user interfaces, and halting the operation of one or more VM. According to yet other embodiments of the invention, the intrusion event is reported to a hypervisor enforcement engine. According to still other embodiments of the invention, forensic content comprises content that allows determination of critical events in the system. According to yet other embodiments of the invention, the forensic data may be analyzed in real time.

According to still other embodiments of the invention, one or more of network traffic, sources, and sinks are monitored to ensure that traffic over them is authorized.

According to embodiments of the invention, a user is permitted to interact with an event involving a suspected intrusion using a hypervisor layer. According to other embodiments of the invention, use of the hypervisor layer permits control of one or more of storage and network more robustly than may be possible from inside the operating system that is being controlled. According to still other embodiments of the invention, security may be added via use of the hypervisor layer given the potential for thereby limiting the transmission of malevolent events. According to embodiments of the invention, when a VM experiences an intrusion alarm, the VM will be paused by the hypervisor layer. According to embodiments of the invention, the client will be prompted with a warning and a notice that may read, for example, “Click here to reset your environment to a default wiped-clean state.”

According to embodiments of the invention, on discovery of one or more of unexpected activity, suspicious activity, unexpected inactivity, and suspicious inactivity, the system performs forensics. According to other embodiments of the invention, the forensics performed by the system include one or more of un-pausing the VM, and directing the VM to allow the unexpected/suspicious behavior to facilitate forensic analysis of the unexpected/suspicious behavior. According to yet other embodiments of the invention, the system creates an artificial environment in which one or more of unexpected activity, suspicious activity, unexpected inactivity, and suspicious inactivity cannot harm the system and in which every packet is logged. According to yet further embodiments of the invention, the system creates an artificial environment in which it can trace all activity by an intruder. According to yet other embodiments of the invention, the VM can be unpaused so that the system can capture real-time events.

According to embodiments of the invention, a privileged user with sufficient permissions as defined by the customer may be authorized, following a suspected intrusion, to unpause the VM and to direct the VM to proceed regardless of the apparent threat. According to embodiments of the invention, an even more privileged user with sufficient permissions as defined by the customer may be authorized to direct the VM to always allow the suspicious behavior, for one or more of just that user, for that user's group, for that user's location, for that user's company, for all companies, and so on. According to further embodiments of the invention, the system creates one or more simulated environments within a VM. According to yet further embodiments of the invention, one or more of the simulated environments can be paused. According to still further embodiments of the invention, one or more of the simulated environments can be moved around.

According to embodiments of the invention, the intrusion prevention system focuses on a single application on a dedicated virtual machine. This serves to dramatically reduce the rate of false positives, and improves the user experience by dedicating the entire process to fit into a single application.

### DESCRIPTION OF THE DRAWINGS

FIG. 1 is a conceptual block diagram showing an exemplary embodiment of the invention.

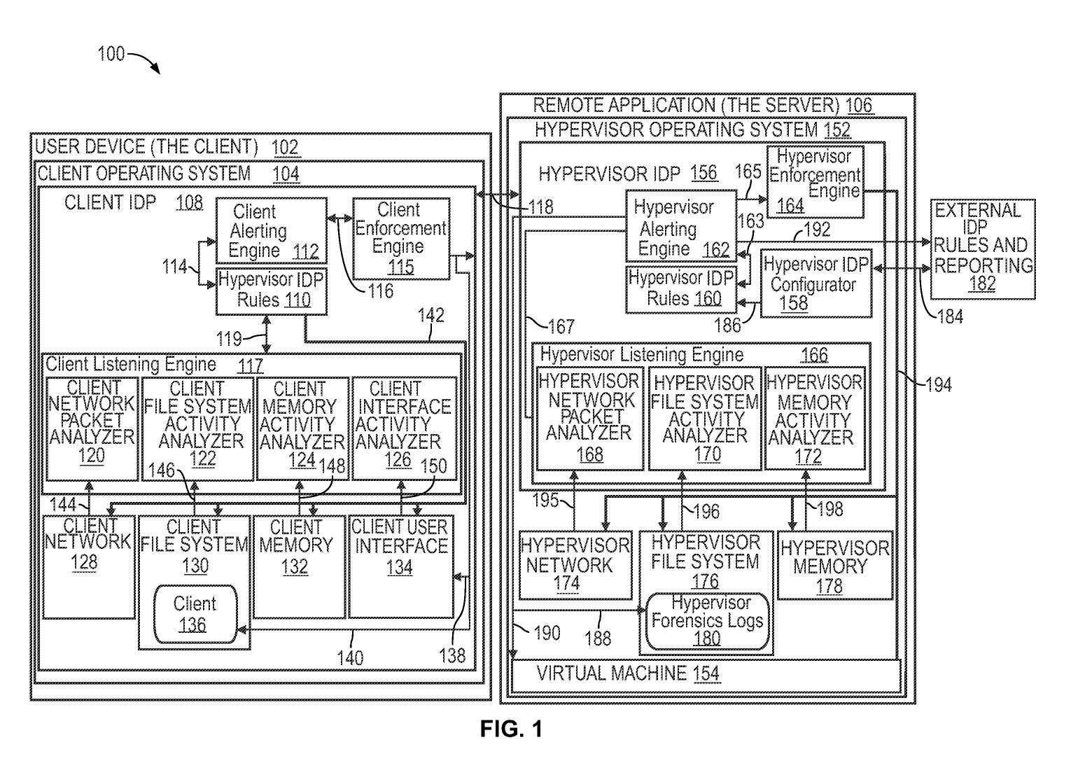

FIG. 2 is a flowchart of a method for intrusion prevention in a client-server system

### DETAILED DESCRIPTION

The figure is a conceptual block diagram showing an exemplary embodiment 100 of the invention. Depicted is a client/server system 100 for detecting malicious activity and preventing cyber-security intrusions, where the client 102 is a user device 102. For example, the user device 102 may be one or more of a personal computer, a laptop computer, a mobile computing device, a tablet, and the like. The client 102 may comprise a client operating system 104.

The system 100 also may comprise a remote application 106 or server 106. The hypervisor 106 comprises one or more of software, firmware, and hardware configured to create and run virtual machines. Use of the hypervisor 106 essentially permits the creation of a safe replica of the client 102 in which investigations may be performed, threats may be analyzed and neutralized, and the strategies, approaches and techniques that have been verified to be safe and efficacious may then be applied to the client 102 while other strategies, approaches and techniques not verified to be safe and efficacious may be avoided without threat to the client 102.

According to other embodiments of the invention, use of the hypervisor layer permits control of one or more of storage and network more robustly than may be possible from inside the operating system that is being controlled. According to still other embodiments of the invention, security may be added via use of the hypervisor layer given the potential for thereby limiting the transmission of malevolent events.

The client operating system 104 may comprise a client IDP 108. The client IDP 108 may comprise client IDP rules 110. The client IDP 108 may comprise a client alerting engine 112. The client alerting engine 112 may be operably connected with the client operating system 104 via a client operating system-alerting engine connection 113. The client alerting engine 112 may be operably connected with the client IDP rules 110 via a client IDP rules-alerting engine connection 114. The client alerting engine 112 may be configured to receive input from the client IDP rules 110 via the client IDP rules-alerting engine connection 114 informing the client alerting engine 112 of applicable IDP rules relating to a possible intrusion event.

The client IDP 108 may comprise a client enforcement engine 115. The client alerting engine 112 may be operably connected with the client enforcement engine 115 via a client alerting engine-enforcement engine connection 116. The client enforcement engine 115 may be configured to receive input from the client alerting engine 112 via the client alerting engine-enforcement engine connection 116 alerting the client enforcement engine 115 as to a possible intrusion event.

The client IDP 108 may comprise a client listening engine 117. Via the client alerting engine 112, the client 102 may be interactively connected to the remote application 106 over a system network 118. The system network 118 will preferably be encrypted. The client alerting engine 112 may be operably connected with the client listening engine 117 via a client alerting engine-listening engine connection 119 so that the client listening engine 112 can notify the client listening engine of a possible intrusion event.

The client listening engine 117 may comprise a client network packet analyzer 120. The client listening engine 117 may comprise a client file system activity analyzer 122. The client listening engine 117 may comprise a client memory activity analyzer 124. The client listening engine 117 may comprise a client interface activity analyzer 126.

The client operating system 104 may comprise a client network 128. The client network 128 will preferably be encrypted. The client operating system 104 may comprise a client file system 130. The client operating system 104 may comprise client memory 132. The client operating system 104 may comprise a client user interface 134. The client file system 130 may comprise client forensic logs 136. The client forensic logs 136 may comprise data that allow the client 102 to review events and ascertain what happened. According to embodiments of the invention, the client 102 may analyze the client forensic logs 136 in real-time.

The client alerting engine 112 may be operably connected to the client user interface 134 via a client alerting engine-user interface connection 138. The client alerting engine 112 may alert the client 102 as to possible intrusion events by sending an alerting message to the client user interface 134 via the client alerting engine-user interface connection 138.

The client alerting engine 112 may be operably connected to the client forensic logs 136 via a client alerting engine-forensic logs connection 140. The client alerting engine 112 may alert the client 102 as to possible intrusion events by sending an alerting message to the client forensic logs 136 via the client alerting engine-forensic logs connection 140.

The client enforcement engine 115 may be operably connected via a client enforcement engine connection 142 to one or more of the client network 128, the client file system 130, the client memory 132, and the client user interface 134. Via client alerting engine-enforcement engine connection 116, the client enforcement engine 115 may receive instructions from the client alerting engine 112. Based on the received instructions, using available information including the process of elimination, the client enforcement engine 115 may determine whether a given event is likely to constitute a security intrusion.

Depending on its determination, the client enforcement engine 115 may prompt one or more of an intrusion alarm, a reset, and a continued alert status. Using the client enforcement engine connection 142, the client enforcement engine 115 may transmit to one or more of the client network 128, the client file system 130, the client memory 132, and the client user interface 134 requirements as to how to proceed regarding a possible intrusion event.

The client network 128 may be operably connected to the client network packet analyzer 120 via a client network-network packet analyzer connection 144. Via the client network-network packet analyzer connection 144, the client network packet analyzer 120 may receive information regarding one or more packets that have passed through the client network 128. The client network packet analyzer 120 may analyze the information received regarding one or more packets that have passed through the client network 128. The client network packet analyzer 120 may be configured to detect malicious activity occurring within the client network 128. The client network packet analyzer 120 looks for any activity in the client network 128 other than expected input and output.

The client file system 130 may be operably connected to the client file system activity analyzer 122 via a client file system-file system activity analyzer connection 146. Via the client file system-file system activity analyzer connection 146, the client file system activity analyzer 122 may receive information regarding one or more of activity and inactivity of the client file system 130. The client file system activity analyzer 122 may analyze the information received regarding the one or more of activity and inactivity of the client file system 130. The client file system activity analyzer 122 may be configured to detect malicious activity occurring within the client file system 130. The file system activity analyzer 122 looks for any activity in the client file system 130 other than expected input and output.

The client memory 132 may be operably connected to the client memory activity analyzer 124 via a client memory-memory activity analyzer connection 148. Via the client memory-memory activity analyzer connection 148, the client memory activity analyzer 124 may receive information regarding one or more of activity and inactivity of the client memory 132. The client memory activity analyzer 124 may analyze the information received regarding the one or more of activity and inactivity of the client memory 132. The client memory activity analyzer 124 may be configured to detect malicious activity occurring within the client memory 132. The client memory activity analyzer 124 looks for any activity in the client memory 132 other than expected input and output.

The client user interface 134 may be operably connected to the client interface activity analyzer 126 via a client user interface-interface activity analyzer connection 150. Via the client user interface-user interface activity analyzer connection 150, the client interface activity analyzer 126 may receive information regarding one or more of activity and inactivity of the client user interface 134. The client interface activity analyzer 126 may analyze the information received regarding the one or more of activity and inactivity of the client user interface 134. The client interface activity analyzer 126 may be configured to detect malicious activity occurring within the client user interface 134. The client interface activity analyzer 126 looks for any activity in the client user interface 134 other than expected input and output.

For example, via the client IDP rules-alerting engine connection 114, the client IDP rules 110 may send to the client alerting engine 112 IDP rules that are to be used by the client alerting engine 112. These IDP rules may be used by the client alerting engine 112 in determining when to perform one or more of: transmitting an alert to the client operating system 104 via the client operating system-alerting engine connection 113, transmitting an alert to the client enforcement engine 115 via the client alerting engine-enforcement engine connection 116, transmitting an alert to the client listening engine 117 via the client alerting engine-listening engine connection 119, transmitting an alert to the client user interface 134 via the client alerting engine-user interface connection 138, and transmitting an alert to the client forensic logs 136 via the client alerting engine-forensic logs connection 140.

Examples of activity that may occur in one or more of the client network 128, the client file system 130, the client memory 132, and the client user interface 134, and that may be analyzed by one or more of the client network packet analyzer 120, the client file system activity analyzer 122, the client memory activity analyzer 124, and the client interface activity analyzer 126 may comprise one or more of mouse clicks, a suspicious content transfer, a cut and paste, a drag and drop, a print function, a download, a connection to the Internet over a port other than one or more of ports 80 and 443, memory access to a resource other than the client memory 132, file system access to a resource other than the client file system 130, and the like.

For example, via the client network-network packet analyzer connection 144, the client network packet analyzer 120 may receive from the client network 128 information regarding one or more of a suspicious mouse click, a suspicious cut and paste, a suspicious content transfer, and the like, indicating possible malicious activity. The client listening engine 117 receives this information from the client network packet analyzer 120. Via the client alerting engine-listening engine connection 119, the client listening engine 117 may transmit this information on the possible malicious activity to the client alerting engine 112.

For example, via the client file system-file system activity analyzer connection 146, the client file system activity analyzer 122 may receive from the client file system 130 information regarding one or more of a suspicious screensaver activation, a suspicious file save, a suspicious file delete, a suspicious file transfer, a suspicious locking of the computer, and the like, indicating possible malicious activity. The client listening engine 117 receives this information from the client file system activity analyzer 122. Via the client alerting engine-listening engine connection 119, the client listening engine 117 may transmit this information on the possible malicious activity to the client alerting engine 112.

For example, via the client memory-memory activity analyzer connection 148, the client memory activity analyzer 124 may receive from the client memory 132 information regarding one of more of a suspicious memory save, a suspicious memory delete, a suspicious memory overwrite, a suspicious memory reassignment, a suspicious locking of a sector of memory, a suspicious locking of the computer, and the like, indicating possible malicious activity. The client listening engine 117 receives this information from the client memory activity analyzer 124. Via the client alerting engine-listening engine connection 119, the client listening engine 117 may transmit this information on the possible malicious activity to the client alerting engine 112.

For example, via the client user interface-interface activity analyzer connection 150, the client interface activity analyzer 126 may receive from the client user interface 134 information regarding one of more of a suspicious screensaver activation, a suspicious mouse click, a suspicious cut and paste, a suspicious content transfer, a suspicious save, a suspicious delete, a suspicious overwrite, a suspicious transfer, a suspicious locking of the computer, and the like, indicating possible malicious activity. The client listening engine 117 receives this information from the client interface activity analyzer 126. Via the client alerting engine-listening engine connection 119, the client listening engine 117 may transmit this information on the possible malicious activity to the client alerting engine 112.

Whatever the source or sources of information on the possible malicious activity, the client alerting engine 112, guided by the client IDP rules 110 that are communicated to it via the client IDP rules-alerting engine connection 114, determines when to perform one or more of: transmitting an alert to the client operating system 104 via the client operating system-alerting engine connection 113, transmitting an alert to the client enforcement engine 115 via the client alerting engine-enforcement engine connection 116, transmitting an alert to the client listening engine 117 via the client alerting engine-listening engine connection 119, transmitting an alert to the client user interface 134 via the client alerting engine-user interface connection 138, and transmitting an alert to the client forensic logs 136 via the client alerting engine-forensic logs connection 140.

To reduce false positive alarms, the client listening engine 117 may be configured to monitor client activity by the client 102 by receiving information regarding client activity from one of more of the client network packet analyzer 120, the client file system activity analyzer 122, the client memory activity analyzer 124, and the client interface activity analyzer 126. To further reduce false positive alarms, the client listening engine 117 may be configured to transmit information regarding client activity to the client alerting engine 112 via the client alerting engine-listening engine connection 119. To further reduce positive alarms, the client user interface 134 may be configured to transmit via the client user interface 138 information on client activity to the client alerting engine 112.

Examples of inactivity that may occur in one or more of the client network 128, the client file system 130, the client memory 132, and the client user interface 134, and that may be analyzed by one or more of the client network packet analyzer 120, the client file system activity analyzer 122, the client memory activity analyzer 124, and the client interface activity analyzer 126 may comprise one or more of screensaver activation, locking of the computer, idle status of the computer, and the like.

According to embodiments of the invention, one or more of any activity and any inactivity that is detected that departs from expected behavior by the client 102 can quickly be identified as potentially malicious. For a computer application, for example, an Internet browser, any connections to the Internet on one or more of ports 80 and 443 may be expected, with connections over any other port being potentially malicious. For example, any memory access to the application process may be expected, with memory access to any other resource being potentially malicious. For example, any disk access to the cache folder may be expected, with disk access to any other resource being potentially malicious.

The remote application 106 may comprise a hypervisor operating system 152. The hypervisor operating system 152 may comprise a virtual machine (VM) 154. The hypervisor operating system 152 may comprise a hypervisor IDP 156. Use of the hypervisor operating system 152 may have distinct advantages in offering a client 102 a degree of control and safety not available when operations are performed on the client operating system 104.

The hypervisor IDP 156 may comprise a hypervisor IDP configurator 158. The hypervisor IDP 156 may comprise hypervisor IDP rules 160. The hypervisor IDP 156 may comprise a hypervisor alerting engine 162. Via the hypervisor alerting engine 162, the remote application 106 may be interactively connected to the client 102 over the system network 118. The hypervisor alerting engine 162 may be operably connected with the hypervisor IDP rules 160 via a hypervisor IDP rules-alerting engine connection 163.

The hypervisor IDP 156 may be configured to recreate a portion of the client IDP 110. For example, the hypervisor IDP 156 may recreate a client-side clipboard (not shown) comprised in the client IDP 110. For example, the hypervisor IDP 156 may recreate a client-side drag and drop utility (not shown) comprised in the client IDP 110.

The hypervisor IDP 156 may comprise a hypervisor enforcement engine 164. The hypervisor alerting engine 162 may be operably connected with the hypervisor enforcement engine 164 via a hypervisor alerting engine-enforcement engine connection 165. The hypervisor enforcement engine 164 may be configured to receive input from the hypervisor alerting engine 162 via the hypervisor alerting engine-enforcement engine connection 165 alerting the hypervisor enforcement engine 164 as to a possible intrusion event.

The hypervisor IDP 156 may comprise a hypervisor listening engine 166. The hypervisor alerting engine 162 may be operably connected with the hypervisor listening engine 166 via a hypervisor alerting engine-listening engine connection 167.

The hypervisor listening engine 166 may comprise a hypervisor network packet analyzer 168. The hypervisor listening engine 166 may comprise a hypervisor file system activity analyzer 170. The hypervisor listening engine 166 may comprise a hypervisor memory activity analyzer 172.

The hypervisor operating system 152 may comprise a hypervisor network 174. The hypervisor network 174 will preferably be encrypted. The hypervisor operating system 152 may comprise a hypervisor file system 176. The hypervisor operating system 152 may comprise hypervisor memory 178. The hypervisor file system 176 may comprise hypervisor forensic logs 180. The hypervisor forensic logs 180 may comprise data that allows the remote application 106 to review events and ascertain what happened. According to embodiments of the invention, the remote application 106 may analyze the hypervisor forensic logs 180 in real-time.

The system 100 may comprise an external IDP rules and reporting 182 configured to store one or more of IDP rules and IDP reports in a location external to the hypervisor operating system 106 and external to the client 102.

The external IDP rules and reporting 182 may be operably connected to the hypervisor IDP configurator 158 via external IDP rules and reporting-hypervisor IDP configurator connection 184. The hypervisor IDP configurator 158 may be operably connected to the hypervisor IDP rules 160 via a hypervisor IDP configurator-IDP rules connection 186.

Via the external IDP rules and reporting-hypervisor IDP configurator connection 184, the hypervisor IDP configurator 158 may transmit to the hypervisor IDP rules 160 instructions on configuring its rules. Via the hypervisor IDP configurator-IDP rules connection 186, the external IDP rules and reporting 182 may transmit to the hypervisor IDP configurator 158 information on IDP rules and reporting to be applied by the hypervisor IDP configurator 158 in configuring the hypervisor operating system 152. Via the hypervisor IDP configurator-IDP rules connection 186, the hypervisor IDP configurator 158 may transmit to the external IDP rules and reporting 182 information on one or more of IDP rules and IDP reports.

The hypervisor alerting engine 162 may be operably connected to the hypervisor forensic logs 180 via a hypervisor alerting engine-forensic logs connection 188. The hypervisor alerting engine 162 may be operably connected to the VM 154 via a hypervisor alerting engine-VM connection 190. The hypervisor alerting engine 162 may be operably connected to the external IDP rules and reporting 182 via a hypervisor alerting engine-external IDP rules and reporting connection 192.

The hypervisor alerting engine 162 may alert the system 100 as to possible intrusion events by sending an alerting message to the external IDP rules and reporting 182 via the hypervisor alerting engine-external IDP rules and reporting connection 192.

The hypervisor enforcement engine 164 may be operably connected via a hypervisor enforcement engine connection 194 to one or more of the hypervisor network 174, the hypervisor file system 176, and the hypervisor memory 178.

The hypervisor network 174 may be operably connected to the hypervisor network packet analyzer 168 via a hypervisor network-network packet analyzer connection 195. Via hypervisor alerting engine-enforcement engine connection 165, the hypervisor enforcement engine 164 may receive instructions from the hypervisor alerting engine 162. Based on the received instructions, using available information including the process of elimination, the hypervisor enforcement engine 164 may determine whether a given event is likely to constitute a security intrusion.

Depending on its determination, the hypervisor enforcement engine 164 may prompt one or more of an intrusion alarm, a reset, and a continued alert status. Using the hypervisor enforcement engine connection 194, the hypervisor enforcement engine 164 may transmit to one or more of the hypervisor network 174, the hypervisor file system 176, and the hypervisor memory 178 requirements as to how to proceed regarding a possible intrusion event.

Via the hypervisor network-network packet analyzer connection 195, the hypervisor network packet analyzer 168 may receive information regarding one or more packets that have passed through the hypervisor network 174. The hypervisor network packet analyzer 168 may analyze the information received regarding one or more packets that have passed through the hypervisor network 174. The hypervisor network packet analyzer 168 may be configured to detect malicious activity occurring within the hypervisor network 174. The hypervisor network packet analyzer 168 looks for any activity in the hypervisor network 174 other than expected input and output.

The hypervisor file system 176 may be operably connected to the hypervisor file system activity analyzer 170 via a hypervisor file system-file system activity analyzer connection 196. Via the hypervisor file system-file system activity analyzer connection 196, the hypervisor file system activity analyzer 170 may receive information regarding one or more of activity and inactivity of the hypervisor file system 176. The hypervisor file system activity analyzer 170 may analyze the information received regarding the one or more of activity and inactivity of the hypervisor file system 176. The hypervisor file system activity analyzer 170 may be configured to detect malicious activity occurring within the hypervisor file system 176. The hypervisor file system activity analyzer 170 looks for any activity in the hypervisor file system 176 other than expected input and output.

The hypervisor memory 178 may be operably connected to the hypervisor memory activity analyzer 172 via a hypervisor memory-memory activity analyzer connection 198. Via the hypervisor memory-memory activity analyzer connection 198, the hypervisor memory activity analyzer 172 may receive information regarding one or more of activity and inactivity of the hypervisor memory 178. The hypervisor memory activity analyzer 172 may analyze the information received regarding the one or more of activity and inactivity of the hypervisor memory 178. The hypervisor memory activity analyzer 172 may be configured to detect malicious activity occurring within the hypervisor memory 178. The hypervisor memory activity analyzer 172 looks for any activity in the hypervisor memory 178 other than expected input and output.

For example, via the hypervisor IDP rules-alerting engine connection 163, the hypervisor IDP rules 160 may send to the hypervisor alerting engine 162 IDP rules that are to be used by the hypervisor alerting engine 162. These IDP rules may be used by the hypervisor alerting engine 162 in determining when to perform one or more of: transmitting an alert to the VM 154 via the hypervisor alerting engine-VM connection 190, transmitting an alert to the hypervisor enforcement engine 164 via the hypervisor alerting engine-enforcement engine connection 165, transmitting an alert to the hypervisor listening engine 162 via the hypervisor alerting engine-listening engine connection 167, transmitting an alert to the hypervisor forensic logs 180 via hypervisor alerting engine-forensic logs connection 188, and transmitting an alert to the external IDP rules and reporting 182 via the hypervisor alerting engine-external IDP rules and reporting connection 192.

Examples of activity that may occur in one or more of the hypervisor network 174, the hypervisor file system 176, and the hypervisor memory 178, and that may be analyzed by one or more of the hypervisor network packet analyzer 168, the hypervisor file system activity analyzer 170, and the hypervisor memory activity analyzer 172 may comprise one or more of mouse clicks, a cut and paste, a drag and drop, a print function, a download, a connection to the Internet over a port other than one or more of ports 80 and 443, memory access to a resource other than the application process, disk access to a resource other than the cache folder, [Walter/Branden—we need to know the names in this invention for the cache folder and the application process] and the like.

For example, via the hypervisor network-network packet analyzer connection 195, the hypervisor network packet analyzer 168 may receive from the hypervisor network 174 information regarding one or more of a suspicious mouse click, a suspicious cut and paste, a suspicious content transfer, and the like, indicating possible malicious activity. The hypervisor listening engine 166 receives this information from the hypervisor network packet analyzer 168. Via the hypervisor alerting engine-listening engine connection 167, the hypervisor listening engine 166 may transmit this information on the possible malicious activity to the hypervisor alerting engine 167.

For example, via the hypervisor file system-file system activity analyzer connection 196, the hypervisor file system activity analyzer 170 may receive from the hypervisor file system 176 information regarding one or more of a suspicious screensaver activation, a suspicious file save, a suspicious file delete, a suspicious file transfer, a suspicious locking of the computer, and the like, indicating possible malicious activity. The hypervisor listening engine 166 receives this information from the hypervisor file system activity analyzer 170. Via the hypervisor alerting engine-listening engine connection 167, the hypervisor listening engine 166 may transmit this information on the possible malicious activity to the hypervisor alerting engine 162.

For example, via the hypervisor memory-memory activity analyzer connection 198, the hypervisor memory activity analyzer 172 may receive from the hypervisor memory 178 information regarding one of more of a suspicious memory save, a suspicious memory delete, a suspicious memory overwrite, a suspicious memory reassignment, a suspicious locking of a sector of memory, a suspicious locking of the computer, and the like, indicating possible malicious activity. The hypervisor listening engine 166 receives this information from the hypervisor memory activity analyzer 172. Via the hypervisor alerting engine-listening engine connection 167, the hypervisor listening engine 166 may transmit this information on the possible malicious activity to the hypervisor alerting engine 162.

Whatever the source or sources of information on the possible malicious activity, the hypervisor alerting engine 162, guided by the hypervisor IDP rules 160 that are communicated to it via the hypervisor IDP rules-alerting engine connection 163, determines when to perform one or more of: transmitting an alert to the VM 154 via the hypervisor alerting engine-VM connection 190, transmitting an alert to the hypervisor enforcement engine 164 via the hypervisor alerting engine-enforcement engine connection 165, transmitting an alert to the hypervisor listening engine 162 via the hypervisor alerting engine-listening engine connection 167, transmitting an alert to the hypervisor forensic logs 180 via hypervisor alerting engine-forensic logs connection 188, and transmitting an alert to the external IDP rules and reporting 182 via the hypervisor alerting engine-external IDP rules and reporting connection 192.

To reduce false positive alarms, the client listening engine 117 may be configured to monitor client activity by the client 102 by receiving information regarding client activity from one of more of the client network packet analyzer 120, the client file system activity analyzer 122, the client memory activity analyzer 124, and the client interface activity analyzer 126. To further reduce false positive alarms, the client listening engine 117 may be configured to transmit information regarding client activity to the client alerting engine 112 via the client alerting engine-listening engine connection 119. To further reduce positive alarms, the client user interface 134 may be configured to transmit via the client user interface 138 information on client activity to the client alerting engine 112.

Examples of inactivity that may occur in one or more of the client network 128, the client file system 130, the client memory 132, and the client user interface 134, and that may be analyzed by one or more of the client network packet analyzer 120, the client file system activity analyzer 122, the client memory activity analyzer 124, and the client interface activity analyzer 126 may comprise one or more of screensaver activation, locking of the computer, idle status of the computer, and the like.

According to embodiments of the invention, one or more of any activity and any inactivity that is detected that departs from expected behavior by the client 102 can quickly be identified as potentially malicious. For a computer application, for example, an Internet browser, any connections to the Internet on one or more of ports 80 and 443 may be expected, with connections over any other port being potentially malicious. For example, any memory access to the application process may be expected, with memory access to any other resource being potentially malicious. For example, any disk access to the cache folder may be expected, with disk access to any other resource being potentially malicious.

Relative to existing technology, the user's experience is enhanced according to embodiments of the invention by allowing for interaction with the virtual machine 154 through the client alerting engine 112. Via client alerting engine-operating system connection 113, the client 102 can be alerted by the client alerting engine 112 whenever a potential intrusion occurs. Alternatively, the client 102 can be alerted by the client alerting engine 112 whenever a potential intrusion matching preselected criteria occurs.

If such a potential intrusion occurs, the client alerting engine 112 alerts the client 102 by one or more of an electronic mail message, text message, screen popup message, voice message, telephone call, and another notification method. The client alerting engine 112 may then optionally offer the client 102 the opportunity to use the client operating system 104 to perform a desired action on the remote application 106. For example, the client 102 can choose to pause the remote application 106. For example, the client can choose to reset the remote application 106. This ability to temporarily halt or to reset execution of operations in the remote application enables the client 102 to decide whether to allow the system 100 to proceed, or alternatively whether to order a reset process so that any potential harm can be minimized. Effectively the client 102 is offered a safe, robust laboratory in which to test the success of any desired intervention prior to applying it to the “real world” of the client operating system 104.

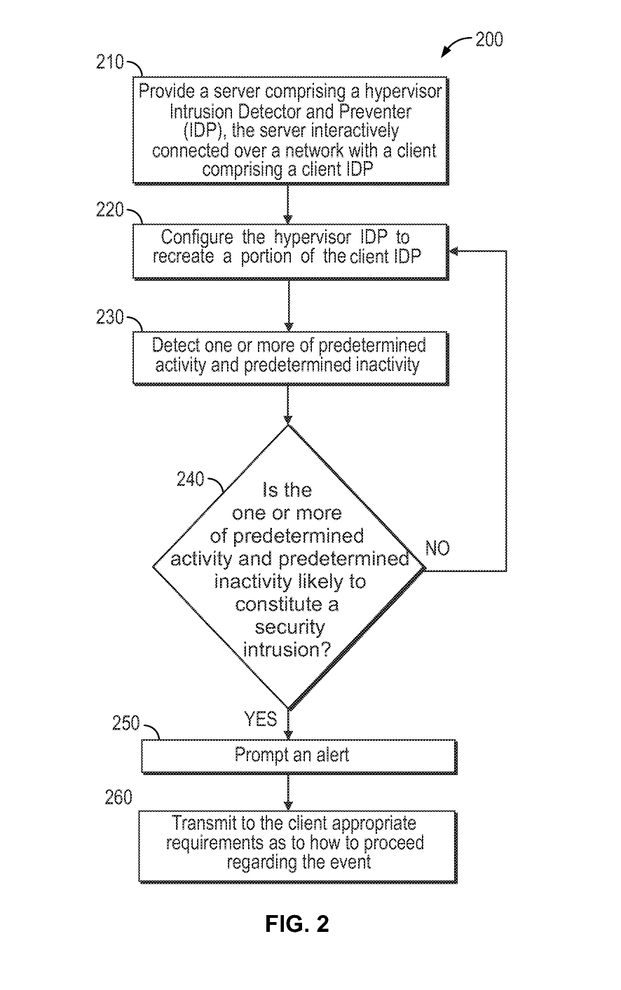

FIG. 2 is a flowchart of a method 200 for intrusion prevention in a client-server system. The order of the steps in the method 200 is not constrained to that shown in FIG. 2 nor is it constrained to that described in the following discussion. Several of the steps could occur in a different order without affecting the final result.

In block 210, a server is provided comprising a hypervisor IDP, the hypervisor IDP comprising: a hypervisor listening engine, a hypervisor enforcement engine, and a hypervisor alerting engine operably connected with both the hypervisor listening engine and the hypervisor enforcement engine, the server interactively connected over a network with a client comprising a client IDP. Block 210 then transfers control to block 220.

In block 220, the server configures the hypervisor IDP to recreate a portion of the client IDP. Block 220 then transfers control to block 230.

In block 230, using the hypervisor listening engine, the server detects one or more of predetermined activity and predetermined inactivity in one or more of a hypervisor network, a hypervisor file system, and a hypervisor memory. Block 230 then transfers control to block 240.

In block 240, using the hypervisor enforcement engine, the server determines if the one or more of predetermined activity and predetermined inactivity is likely to constitute a security intrusion. If the answer to the question is yes, then block 240 then transfers control to block 250. If the answer to the question is no, then the process loops back to block 220.

In block 250, using the hypervisor alerting engine, the server prompts an alert. Block 250 then transfers control to block 260.

In block 260, using the hypervisor enforcement engine, the server transmits to the client appropriate requirements as to how to proceed regarding the event. Block 260 then terminates the process.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain fabrication steps and certain components can be altered without substantially impairing the functioning of the invention. For example, the hypervisor alerting engine 162 could be located outside of the remote application 106. Similarly, the hypervisor enforcement engine 164 could be located outside the remote application 106. As another example, the external IDP rules and reporting 182 could be located inside the remote application 106.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

What is claimed is:

1. An intrusion prevention system for use in a networked server-client system, comprising:
a server interactively connected over a network with a client comprising a client Intrusion Detector and Preventer (IDP), the server comprising a hypervisor IDP,
the hypervisor IDP being configured to recreate a portion of the client IDP, so as to prevent intrusions into the server-client system.

2. The intrusion prevention system of claim 1, wherein the hypervisor IDP comprises:
a hypervisor listening engine configured to detect one or more of activity and inactivity in one or more of a hypervisor network, a hypervisor file system, and a hypervisor memory;
a hypervisor alerting engine configured to prompt an alarm upon one or more of predetermined activity and predetermined inactivity;
a hypervisor enforcement engine operably connected with the hypervisor alerting engine, wherein the hypervisor enforcement engine is operably connected with the hypervisor listening engine, wherein the hypervisor enforcement engine is configured to determine whether an events that causes an alarm is likely to constitute a security intrusion and to transmit appropriate requirements as to how to proceed regarding the event; and
a virtual machine configured to recreate a portion of the client IDP,
so as to prevent intrusions into the server-client system.

3. The intrusion prevention system of claim 2, wherein the hypervisor IDP comprises a hypervisor network operably connected with the hypervisor enforcement engine, and wherein the hypervisor listening engine comprises a hypervisor network packet analyzer operably connected with the hypervisor network and configured to analyze one or more of activity and inactivity of the hypervisor network.

4. The intrusion prevention system of claim 1, wherein the hypervisor IDP recreates one or more of a client-side clipboard and a client-side drag and drop utility.

5. The intrusion prevention system of claim 2, wherein the hypervisor IDP comprises a hypervisor file system operably connected with the hypervisor enforcement engine, and wherein the hypervisor listening engine comprises a hypervisor file system activity analyzer operably connected with the hypervisor file system and configured to analyze one or more of activity and inactivity of the hypervisor file system.

6. The intrusion prevention system of claim 5, wherein the hypervisor file system comprises hypervisor forensic logs, wherein the hypervisor forensic logs comprise data that allow the client to review possible intrusion events in real-time.

7. The intrusion prevention system of claim 2, wherein the hypervisor IDP comprises a hypervisor memory operably connected with the hypervisor enforcement engine, and wherein the hypervisor listening engine comprises a hypervisor memory activity analyzer operably connected with the hypervisor memory and configured to analyze one or more of activity and inactivity of the hypervisor memory.

8. The intrusion prevention system of claim 2, further including hypervisor IDP rules operably connected with the hypervisor alerting engine, the hypervisor IDP rules configured to send to the hypervisor alerting engine IDP rules to be used by the hypervisor alerting engine.

9. The intrusion prevention system of claim 8, further including a hypervisor IDP configurator operably connected with the hypervisor IDP rules, the hypervisor IDP configurator configured to send to the hypervisor IDP rules instructions on configuring its rules.

10. The intrusion prevention system of claim 2, further including external IDP rules and reporting operably connected with the hypervisor IDP configurator and operably connected with the hypervisor alerting engine, wherein the external IDP rules and reporting is configured to transmit to the hypervisor IDP configurator information on IDP rules and reporting to be applied by the hypervisor IDP configurator in configuring the hypervisor operating system.

11. The intrusion prevention system of claim 2, wherein the client IDP comprises:
a client listening engine configured to detect one or more of activity and inactivity in one or more of a client network, a client file system, a client memory, and a client user interface;
a client alerting engine configured to prompt an alarm upon one or more of predetermined activity and predetermined inactivity;
a client enforcement engine operably connected with the client alerting engine, wherein the client enforcement engine is operably connected with the client listening engine, wherein the client enforcement engine is configured to determine whether a given event is likely to constitute a security intrusion and to transmit appropriate requirements as to how to proceed regarding the event,
so as to prevent intrusions into the server-client system.

12. A method for intrusion prevention in a client-server system, comprising the steps of:
providing a server comprising a hypervisor Intrusion Detector and Preventer (IDP), the hypervisor IDP comprising: a hypervisor listening engine, a hypervisor enforcement engine, and a hypervisor alerting engine operably connected with both the hypervisor listening engine and the hypervisor enforcement engine, the server interactively connected over a network with a client comprising a client IDP;
configuring, by the server, the hypervisor IDP to recreate a portion of the client IDP;
using the hypervisor listening engine, detecting, by the server, one or more of predetermined activity and predetermined inactivity in one or more of a hypervisor network, a hypervisor file system, and a hypervisor memory;
using the hypervisor enforcement engine, determining, by the server, that the one or more of predetermined activity and predetermined inactivity is likely to constitute a security intrusion;
using the hypervisor alerting engine, prompting, by the server, an alert; and
using the hypervisor enforcement engine, by the server, transmitting to the client appropriate requirements as to how to proceed regarding the event,
so as to prevent intrusions into the server-client system.

13. The intrusion prevention method of claim 12, wherein transmitting comprises sending one or more of an alarm, a reset, and a continued alert status.

14. The intrusion prevention method of claim 12, wherein prompting comprises one or more of prompting an alert to the client and prompting an alert to the hypervisor listening engine.

15. The intrusion prevention method of claim 12, wherein prompting comprises prompting an alert to the client.

16. The intrusion prevention method of claim 15, wherein prompting comprises sending the client one or more of an electronic mail message, text message, screen popup message, voice message, telephone call, and another notification.

17. The intrusion prevention method of claim 16, comprising the further step of offering to the client, by the hypervisor alerting engine, the opportunity to perform a desired action on the remote application.

18. The intrusion prevention method of claim 17, wherein offering comprises one or more of offering the client the opportunity to pause the remote application and offering the client the opportunity to reset the remote application.

19. The intrusion prevention method of claim 12, wherein the hypervisor IDP further comprises hypervisor forensic logs, comprising the further step of allowing the client to review possible intrusion events in real-time using information comprised in the hypervisor forensic logs.

20. An intrusion prevention system for use in a networked server-client system, comprising:
a server interactively connected over a network with a client comprising a client Intrusion Detector and Preventer (IDP), the server comprising a hypervisor IDP,
the hypervisor IDP being configured to recreate a portion of the client IDP, wherein the hypervisor IDP comprises:
a hypervisor listening engine configured to detect one or more of activity and inactivity in one or more of a hypervisor network, a hypervisor file system, and a hypervisor memory;
a hypervisor alerting engine configured to prompt an alarm upon one or more of predetermined activity and predetermined inactivity; and
a hypervisor enforcement engine operably connected with the hypervisor alerting engine, wherein the hypervisor enforcement engine is operably connected with the hypervisor listening engine, wherein the hypervisor enforcement engine is configured to determine whether a given event is likely to constitute a security intrusion and to transmit appropriate requirements as to how to proceed regarding the event,
wherein the client IDP comprises:
a client listening engine configured to detect one or more of activity and inactivity in one or more of a client network, a client file system, a client memory, and a client user interface;
a client alerting engine configured to prompt an alarm upon one or more of predetermined activity and predetermined inactivity; and
a client enforcement engine operably connected with the client alerting engine, wherein the client enforcement engine is operably connected with the client listening engine, wherein the client enforcement engine is configured to determine whether a given event is likely to constitute a security intrusion and to transmit appropriate requirements as to how to proceed regarding the event,
so as to prevent intrusions into the server-client system.
